(19) United States
(12) Patent Application Publication
(10) Pub. No.: US 2015/0373239 A1
(43) Pub. Date: Dec. 24, 2015

(54) IMAGE SENSOR MODULE AND CAMERA MODULE INCLUDING THE SAME

(71) Applicant: SAMSUNG ELECTRO-MECHANICS CO., LTD., Suwon-Si (KR)

(72) Inventor: Kyung Hoon Choi, Suwon-Si (KR)

(73) Assignee: SAMSUNG ELECTRO-MECHANICS CO., LTD., Suwon-Si (KR)

(21) Appl. No.: 14/485,507

(22) Filed: Sep. 12, 2014

(30) Foreign Application Priority Data
Jun. 24, 2014 (KR) 10-2014-0077565

(51) Int. Cl. H04N 5/225; G02B 5/20

(52) U.S. Cl. CPC H04N 5/2254; G02B 5/208

(57) ABSTRACT

In an image sensor module, a board may be provided with an accommodating groove and an image sensor may be disposed in the accommodating groove to decrease a space occupied by the image sensor. In addition, a side wall of the accommodating groove may be provided as an inclined surface and a bonding pad may be formed on the inclined surface to decrease a length of a bonding wire for electrically connecting the image sensor and the board to each other, whereby the overall size of the image sensor module may be decreased.

### CROSS-REFERENCE TO RELATED APPLICATION

This application claims the benefit of Korean Patent Application No. 10-2014-0077565 filed on Jun. 24, 2014, with the Korean Intellectual Property Office, the disclosure of which is incorporated herein by reference.

### BACKGROUND

The present disclosure relates to an image sensor module and a camera module including the same.

Generally, camera modules are provided in various information technology (IT) apparatuses such as portable mobile communications apparatuses, and the like, and the miniaturization of camera modules themselves has been demanded in accordance with the recent trend for the miniaturization of portable mobile communications apparatuses.

Such camera modules capture images of subjects through an image sensor such as a charge coupled device (CCD), a complementary metal oxide semiconductor (CMOS), or the like, and store the collected images as data in a memory of an apparatus. To this end, in the camera module, the image sensor is mounted on a board, and a bonding wire is used in order to electrically connect the image sensor and the board to each other.

Here, in the case in which the image sensor is mounted on an upper surface of the board, an overall size of the camera module is increased, due to an amount of space occupied by the image sensor. In addition, the overall size of the camera module is also increased due to a space in which the bonding wire for electrically connecting the image sensor and the board to each other is installed.

### SUMMARY

An exemplary embodiment in the present disclosure may provide an image sensor module capable of decreasing an amount of space occupied by an image sensor and an amount of space in which a bonding wire for electrically connecting the image sensor and a board to each other is installed, and a camera module including the same.

An exemplary embodiment in the present disclosure may also provide an image sensor module capable of decreasing an amount of space occupied by an infrared (IR) filter, and a camera module including the same.

An exemplary embodiment in the present disclosure may also provide an image sensor module capable of preventing foreign objects from infiltrating into an image sensor, and a camera module including the same.

In an image sensor module according to an exemplary embodiment in the present disclosure, a board may be provided with an accommodating groove and an image sensor may be disposed in the accommodating groove to decrease a space occupied by the image sensor, whereby an overall size of the image sensor module may be decreased.

In addition, in the image sensor module according to an exemplary embodiment in the present disclosure, a side wall of the accommodating groove may be provided as an inclined surface and a bonding pad may be formed on the inclined surface to decrease a length of a bonding wire for electrically connecting the image sensor and the board to each other, whereby the overall size of the image sensor module may be decreased.

Further, an infrared (IR) filter having a film form may be attached to an upper surface of the image sensor module according to an exemplary embodiment in the present disclosure, whereby the overall size of the image sensor module may be decreased.

The overall size of the image sensor module may be decreased, whereby an overall size of a camera module according to an exemplary embodiment in the present disclosure may be decreased.

Furthermore, in the camera module according to an exemplary embodiment in the present disclosure, the IR filter may be attached to the image sensor module. Therefore, since the camera module according to an exemplary embodiment in the present disclosure does not include a separate component for attaching the IR filter to an inner portion of a housing, the overall size of the camera module may be decreased.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view of a camera module according to an exemplary embodiment in the present disclosure;

FIG. 2 is an assembled cross-sectional view of the camera module according to an exemplary embodiment in the present disclosure;

FIG. 3 is a partially cut-away perspective view of an image sensor module according to an exemplary embodiment in the present disclosure;

FIG. 4A is an enlarged cross-sectional view of part A of FIG. 2; and

FIGS. 4B and 4C are enlarged cross-sectional views illustrating a modified example of a position of a bonding wire.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Terms with respect to directions will first be defined. An optical axis direction refers to a vertical direction based on a lens barrel 20.

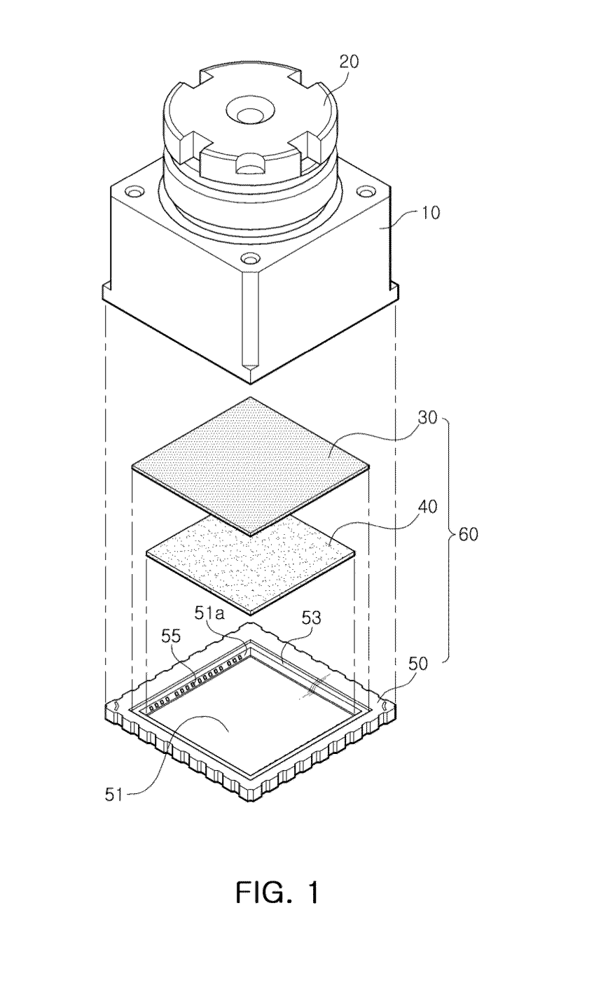

FIG. 1 is an exploded perspective view of a camera module according to an exemplary embodiment in the present disclosure.

Referring to FIG. 1, a camera module according to an exemplary embodiment in the present disclosure may include a lens barrel 20, a housing 10, and an image sensor module 60, wherein the image sensor module 60 includes an image sensor 40 and a board 50.

The housing 10 may accommodate the lens barrel 20 therein. The lens barrel 20 may have a hollow cylindrical shape so that at least one lens photographing a subject may be accommodated therein, and the lens may be provided in the lens barrel 20 along an optical axis.

The lens barrel 20 may be coupled to the housing 10 and be moved in the optical axis direction within the housing 10 in order to perform auto-focusing.

An actuator including a magnet and a coil may be provided within the housing 10 in order to move the lens barrel 20 in the optical axis direction. However, a moving means of the lens barrel 20 is not limited to the actuator including a voice coil motor (VCM). That is, various schemes such as a mechanical driving scheme, a piezoelectric driving scheme using a piezoelectric element, and the like, may be used.

The housing 10, which is to support the lens barrel 20, may accommodate the lens barrel 20 therein.

The housing 10 may have the image sensor module 60 disposed therebelow and have a shape in which it is opened in the optical axis direction.

Therefore, external light may be incident from the outside of the housing 10 to the lens barrel 20, pass through the lens barrel 20, and then arrive at the image sensor module 60.

The image sensor module 60 may include the image sensor 40 and the board 50.

The image sensor 40, which collects light incident through the lens barrel 20 to generate an image signal, may be formed of a complementary metal oxide semiconductor (CMOS) sensor or a charge coupled device (CCD) sensor.

An image of the subject may be collected by the image sensor 40 and be stored as data in a memory of an apparatus, and the stored data may be displayed as the image by a display device of the apparatus.

The image sensor 40 may be mounted on the board 50 and be electrically connected to the board 50 by a bonding wire W.

Meanwhile, the image sensor module 60 may further include an infrared (IR) filter 30.

The IR filter 30 may serve to filter infrared light in the external light incident through the lens within the lens barrel 20.

Therefore, when the light passing through the lens passes through the IR filter 30, infrared light in the light may be filtered. Therefore, the introduction of infrared light into the image sensor 40 may be prevented.

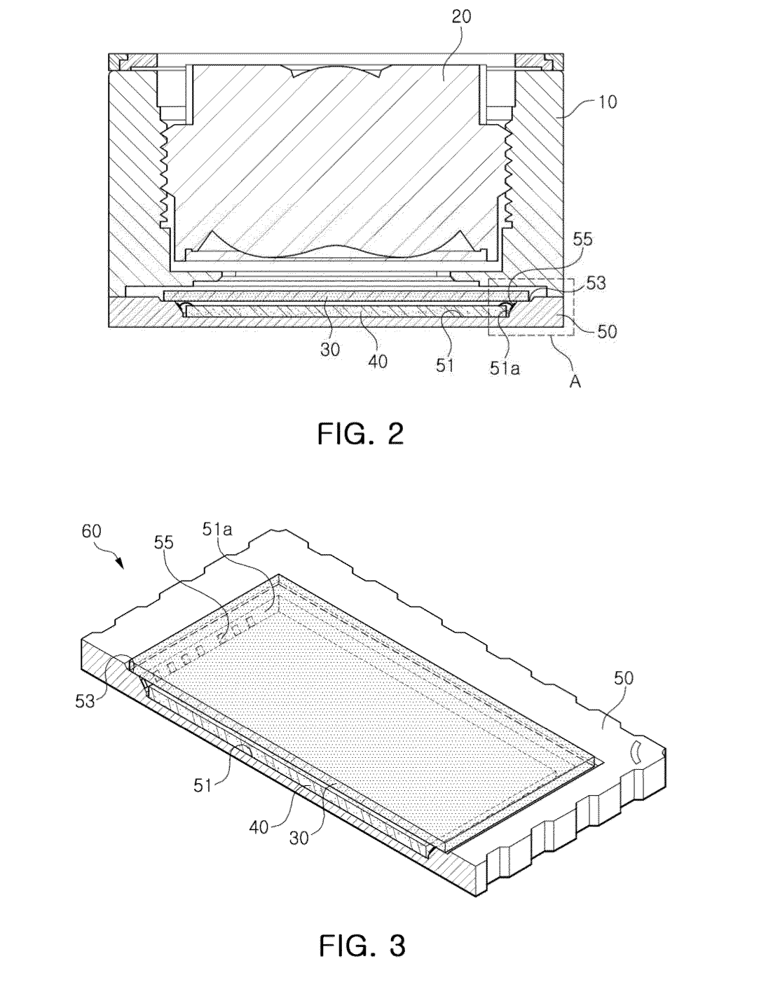

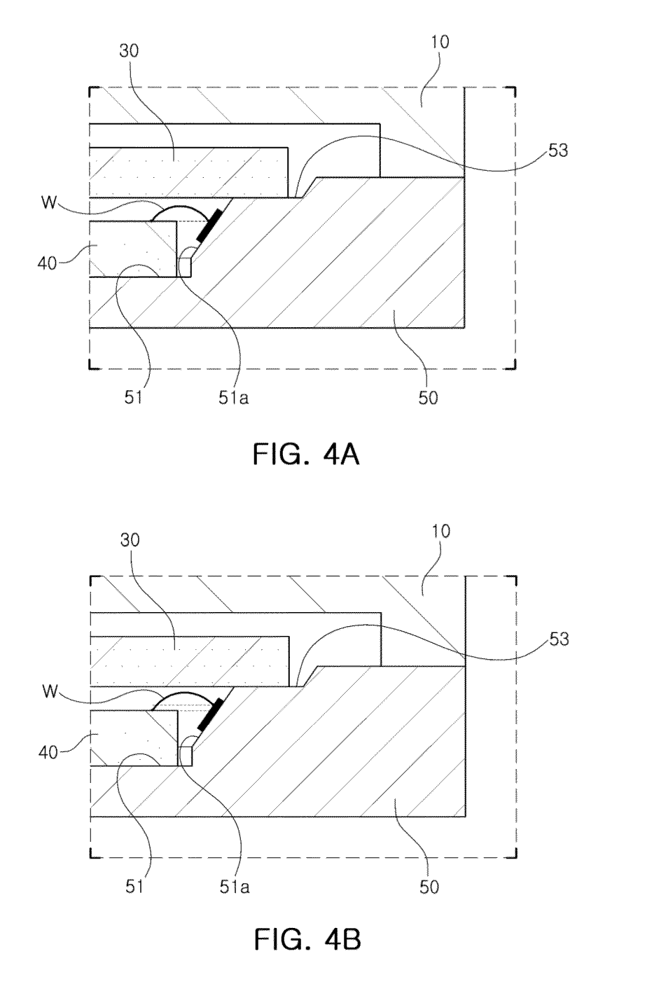

FIG. 2 is an assembled cross-sectional view of the camera module according to an exemplary embodiment in the present disclosure; and FIG. 3 is a partially cut-away perspective view of an image sensor module according to an exemplary embodiment in the present disclosure.

An image sensor module according to an exemplary embodiment in the present disclosure will be described with reference to FIGS. 2 and 3.

The board 50 may be a ceramic board and may be provided with an accommodating groove 51 in which the image sensor 40 is accommodated.

The image sensor 40 may be disposed in the accommodating groove 51. In the case in which the IR filter 30 is mounted on an upper surface of the board 50 as described below, a lower surface of the IR filter 30 and the upper surface of the image sensor 40 may have a predetermined space formed therebetween.

That is, the accommodating groove 51 may have a depth sufficient to accommodate the image sensor 40 such that the image sensor 40 may be spaced apart from the IR filter 30 in the optical axis direction.

Since the image sensor 40 is inserted into and mounted in the accommodating groove 51 as described above, an overall height of the camera module may be decreased as much as a height of the image sensor 40 as compared with the case in which the image sensor 40 is mounted on the upper surface of the board 50.

For example, in the case in which the image sensor 40 is mounted on the upper surface of the board 50, there may be a limitation in decreasing an overall size of the image sensor module 60 due to a height of the board 50, a height of the image sensor 40, and a space occupied by the bonding wire W for electrically connecting the board 50 and the image sensor 40 to each other.

However, in the image sensor module 60 according to an exemplary embodiment in the present disclosure, the accommodating groove 51 is formed in the board 50 and the image sensor 40 is disposed in the accommodating groove 51, whereby a size of the image sensor module 60 may be decreased as much as a space occupied by the image sensor 40.

That is, the space occupied by the image sensor 40 is decreased, whereby a size of the image sensor module 60 may be decreased and an overall size of the camera module including the image sensor module 60 may be deceased.

Here, the image sensor 40 and the board 50 may be electrically connected to each other by the bonding wire W.

The image sensor 40 and the board 50 may be provided with bonding pads, respectively, and the bonding pad of the image sensor 40 and the bonding pad 55 of the board 50 may be electrically connected to each other by the bonding wire W.

In the image sensor module 60 according to an exemplary embodiment in the present disclosure, a side wall 51a of the accommodating groove 51 provided in the board 50 may be provided as an inclined surface, and the bonding pad 55 may be provided on the inclined surface.

The accommodating groove 51 may have a width that becomes wider from a bottom surface thereof toward the image sensor 40 by the inclined surface.

Here, the bonding wire W may be disposed in the accommodating groove 51.

Therefore, the accommodating groove 51 may be formed at a depth sufficient to accommodate both of the image sensor 40 and the bonding wire W therein.

Meanwhile, the image sensor module 60 according to an exemplary embodiment in the present disclosure may further include the IR filter 30.

In this case, the board 50 may have a step part 53 formed on the upper surface thereof so that the IR filter 30 is seated thereon, and the IR filter 30 may be mounted on the upper surface (that is, the step part 53) of the board 50.

In the image sensor module 60 according to an exemplary embodiment in the present disclosure, the IR filter 30 may be provided in a film form.

Therefore, a height of the IR filter 30 may be decreased. As a result, an overall height of the camera module including the image sensor module 60 may be decreased.

Meanwhile, the IR filter 30 may be mounted on the upper surface of the board 50 so as to cover the accommodating groove 51 provided in the board 50.

Therefore, since the accommodating groove 51 is closed by the IR filter 30, introduction of foreign objects into the image sensor 40 may be prevented.

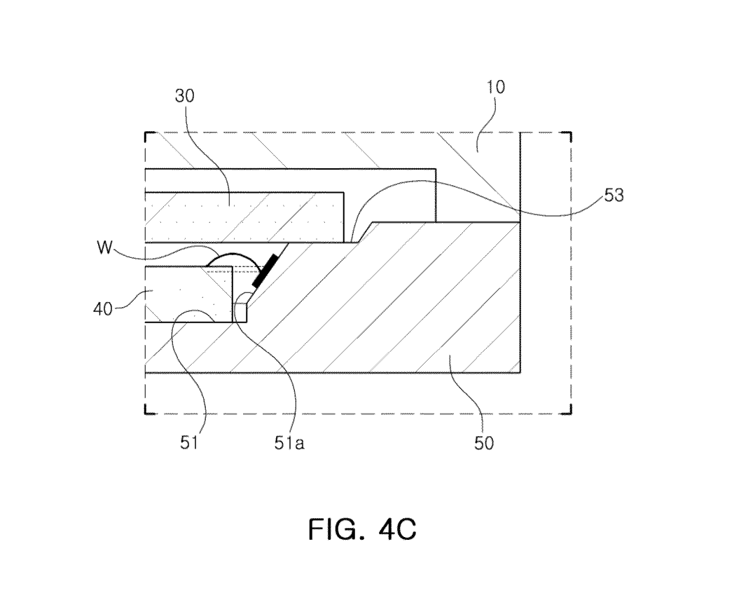

FIG. 4A is an enlarged cross-sectional view of part A of FIG. 2; and FIGS. 4B and 4C are enlarged cross-sectional view illustrating a modified example of a position of a bonding wire.

Referring to FIG. 4A, in the image sensor module 60 according to an exemplary embodiment in the present disclosure, one end of the bonding wire W may be connected to the bonding pad 55 provided on the inclined surface, and the other end thereof may be connected to the bonding pad provided on the upper surface of the image sensor 40.

Since the bonding pad 55 of the board 50 is provided on the side wall 51a of the accommodating groove 51, the board 50 and the image sensor 40 may be connected to each other at the shortest distance.

Therefore, horizontal and vertical lengths of the image sensor module 60 may be decreased.

For example, in the case in which the bonding pad 55 is provided on the upper surface of the board 50, a space required for the bonding wire needs to be secured. Therefore, there may be a limitation in decreasing horizontal and vertical lengths of the board 50.

However, in the image sensor module 60 according to an exemplary embodiment in the present disclosure, since the bonding pad 55 is provided on the side wall 51a of the accommodating groove 51 provided in the board 50, a space required for the bonding wire may be decreased. Therefore, the horizontal and vertical lengths of the board 50 may be decreased. As a result, the overall size of the image sensor module 60 may be decreased.

Meanwhile, in order for the bonding wire W to be disposed in the accommodating groove 51 (that is, in order for the bonding wire W to be disposed so as not to protrude to the outside of the board 50), one end and the other end of the bonding wire W may be on the same plane.

However, the present disclosure is not limited thereto. That is, one end of the bonding wire W may also be positioned in a position higher or lower than that of the other end of the bonding wire W as long as the bonding wire W does not protrude to the outside of the board.

In addition, in the image sensor module 60 according to an exemplary embodiment in the present disclosure, the side wall 51a of the accommodating groove 51 is provided as the inclined surface, whereby a work space at the time of connecting the bonding wire W may be secured.

For example, in the case in which the side wall 51a of the accommodating groove 51 is provided as a vertical surface and the bonding pad 55 is provided on the vertical surface, the image sensor 40 and the bonding pad 55 of the board 50 become very close to each other, such that a space required for connecting the bonding wire W is not secured, thereby causing a difficulty in performing a wire bonding work.

However, in the image sensor module 60 according to an exemplary embodiment in the present disclosure, since the side wall 51a of the accommodating groove 51 is provided as the inclined surface, the space required for the bonding wire W is decreased, whereby the overall size of the image sensor module 60 may be decreased, and the space required for the wire bonding work is secured, whereby productivity may be improved.

In the image sensor module and the camera module including the same according to an exemplary embodiment in the present disclosure, spaces occupied by the image sensor 40, the bonding wire W, and the IR filter 30 are decreased, whereby the overall height of the module may be decreased, and a connection distance of the wire bonding for electrically connecting the image sensor 40 and the board 50 to each other is decreased, whereby the horizontal and vertical lengths of the module may be decreased.

Therefore, the overall size of the module may be further decreased.

As set forth above, in the image sensor module and the camera module including the same according to an exemplary embodiment in the present disclosure, the space occupied by the image sensor and the space in which the bonding wire for electrically connecting the image sensor and the board to each other is installed may be decreased.

In addition, the space occupied by the IR filter may be decreased.

Further, the introduction of the foreign objects into the image sensor may be prevented.

While exemplary embodiments have been shown and described above, it will be apparent to those skilled in the art that modifications and variations could be made without departing from the spirit and scope of the present disclosure as defined by the appended claims.

What is claimed is:

1. An image sensor module comprising:
an image sensor; and
a board including an accommodating groove in which the image sensor is accommodated,
wherein a side wall of the accommodating groove is provided as an inclined surface, and a bonding pad provided on the inclined surface and a bonding pad provided on the image sensor are connected to each other by a bonding wire.

2. The image sensor module of claim 1, wherein the accommodating groove has a width increasing in a direction from a bottom surface thereof toward the image sensor.

3. The image sensor module of claim 1, wherein the bonding wire is disposed in the accommodating groove.

4. The image sensor module of claim 1, wherein one end of the bonding wire is connected to the bonding pad provided on the inclined surface, and the other end thereof is connected to the bonding pad provided on an upper surface of the image sensor.

5. The image sensor module of claim 4, wherein one end and the other end of the bonding wire are on the same plane.

6. The image sensor module of claim 4, wherein one end of the bonding wire is positioned in a position lower than that of the other end of the bonding wire.

7. The image sensor module of claim 4, wherein one end of the bonding wire is positioned in a position higher than that of the other end of the bonding wire.

8. The image sensor module of claim 1, further comprising an infrared (IR) filter disposed on an upper surface of the board.

9. The image sensor module of claim 8, wherein the IR filter covers the accommodating groove.

10. The image sensor module of claim 8, wherein the board has a step part formed in the upper surface thereof on which the IR filter is seated.

11. The image sensor module of claim 8, wherein the IR filter has a film form.

12. The image sensor module of claim 8, wherein a lower surface of the IR filter and an upper surface of the image sensor have a predetermined space formed therebetween.

13. The image sensor module of claim 1, wherein the board is a ceramic board.

14. A camera module comprising:
the image sensor module of claim 1; and
a housing coupled to the image sensor module and accommodating a lens barrel therein.
